(19) United States
(12) Patent Application Publication
(10) Pub. No.: US 2018/0185689 A1
(43) Pub. Date: Jul. 5, 2018

(54) Portable Descent Platform

(71) Applicant: James Scott, Bend, OR (US)

(72) Inventor: James Scott, Bend, OR (US)

(21) Appl. No.: 15/862,565

(22) Filed: Jan. 4, 2018

Related U.S. Application Data
(60) Provisional application No. 62/442,326, filed on Jan. 4, 2017.

(51) Int. Cl. A63B 5/16; B66F 7/22; B60R 9/08

(52) U.S. Cl. CPC A63B 5/16; A63B 2005/163; B60R 9/08; B66F 7/22

(57) ABSTRACT

A portable descent platform for users descending from a rope or elastic cord. The descent platform is engaged upon a planar bed of a powered motor vehicle in a pivoting engagement allowing extension of the platform from the vehicle and numerous angles. The platform may have a first portion in a translational engagement with a second portion to allow for distance adjustment of a distal edge of the platform toward and away from the vehicle and may also include elevational adjustment of the height of the platform.

This application claims priority to U.S. Provisional Patent Application Ser. No. 62/442,326 filed on Jan. 4, 2017, which is included herein in its entirety by this reference thereto.

### BACKGROUND OF THE INVENTION

### 1. Field of the Invention

The present invention relates generally to platforms employed for the sport of bungee jumping and employed for a rope descent such as for fireman and rescue crews. More particularly, the invention relates to a vehicle engaged extendable portable platform having a user support surface for jumping or repelling which is configured for deployment over and past elevated railings with the supporting vehicle parked either parallel or perpendicular to the roadway traversing the bridge or elevated roadway.

### 2. Prior Art

Bungee jumping and rope repelling are activities which involve a user who jumps or repels from a tall structure such as a tower, or building, or bridge. In the case of a bungee jumper the user is operatively connected to a large elastic cord. In the case of a repelling user, for recreation or rescue, the user will leave the safety of a platform or support surface, and repel or be lowered therefrom using a rope or the like.

In cases of bungee jumping or repelling, such tall structures from which the user repels or jumps, is usually a fixed object. In the case of bungee jumping such can include buildings and bridges on which a sturdy support tower is positioned from which the bungee extends to operative engagement with the user. Portable structures are also employed at venues where no tall structure exists such as a crane.

In the sport of bungee jumping, a person jumping generally wears a vest or other body harness which is secured to a first end of an elastic cord. A second end of the elastic cord is secured to a tower or the like. During the activity, the person secured to the elastic cord which is secured to an anchoring object such as a tower, jumps from an elevated platform allowing them to free fall. The thrill comes from this free-falling which stretches the elastic cord which absorbs the force of their falling body, in a slow but steady rate where falling ceases. The jumper then experiences the thrill of the rebound. Thus, when a person secured to the elastic cord jumps, the cord stretches to slow their descent and the jumper subsequently flies upwards again as the cord recoils. This falling and upward rebound continues in an oscillating fashion propelling the user up and down until all the kinetic energy from their mass is dissipated.

In repelling situations, such as for sport, but more often for emergencies or to allow a user to be held elevated above the ground to perform a work task, workers engage a rope to a fixed mount, and then either repel down a support surface, or use the engaged rope in a controlled descent. Such can be a difficult task when using a rope to repel or engage in a controlled descent from a large bridge since such bridges generally have a roadway and a railing on both sides. Users of ropes for repelling or controlled descents, be it for rescue or servicing the bridge, currently must secure to the railing or the like, and have no portable means for rope securement which allows for a fast and easy descent past the guard rail.

In the sport of bungee jumping, many jumping facilities exist in static locales, using towers and the like which are fixed in position, to allow the jumper to become elevated for initiating a jump. However, in recent years it has become ever more popular to execute such bungee jumping from high bridges. Many such bridges exist on highways to span canyons for highways and roads. Bungee jumping from such bridges can provide an extreme thrill during continued acceleration of the fall and the subsequent rebounding, because the distance of travel can occur for hundreds of feet. Thus, jumpers experience a heightened experience by the ability to jump from elevations significantly higher than a crane, tower, or building, and concurrently experience the scenery of the canyon below.

Because of the inherently dangerous aspect of the sport where participants jump from high elevations, most states and municipalities have come to regulate the sport. This has given rise to associations who secure permits to jump from high bridges and has also given rise to professional vendors who offer tours where participants are taken to a large bridge and outfitted with the proper and safe equipment and procedures to take the proverbial plunge safely.

Similar to users executing a rope descent by repelling or travel along a bridge-secured rope, a popular manner of securing bungee jumpers with bridges is to secure the second end of the elastic rope to a part of the extremely strong bridge structure itself. While this also provides a solid engagement for the distal end of the elastic cord secured on the opposite end to the jumper, the need to tie off to the bridge structure itself can severely limit the available bridges for jumping. This is because states and municipalities do not favor using the bridge structure itself as an anchor due to structural failure concerns. Further, such bridge jumping is discouraged by many states and municipalities because during such jumping traffic is must either be blocked, or at a minimum will become snarled due to the positioning of towers and jumping platforms on the bridge itself.

The disclosed device and method herein enables both rope descents and bungee jumping from highway bridges, and does not require the employment of the bridge structure itself, as an anchor for ropes, platforms, towers, or in the case of bungee jumping, the elastic cord used by jumpers. The system herein provides a portable extendable structure adapted for positioning on a bridge in a position extending over and past the side railings. So positioned, the system herein will not block traffic on a multi-lane bridge, and concurrently provides a safe and solid platform extending past the bridge structure, which is employable for rope repelling as well as for bungee jumping and provides an extended tower for rope and bungee securement as well as dispensing and retrieval.

It should be noted, the foregoing examples of related art in bungee jumping platforms and limitations related therewith are intended to be illustrative and not exclusive, and they do not imply any limitations on the device and system described and claimed herein. Various limitations of the related art are already known or will become apparent to those skilled in the art upon a reading and understanding of the specification below and the accompanying drawings.

An object of the present invention is the provision of a portable structure which is configured to extend past and away from bridge structures and provides a safe and secure platform for rope repelling and bungee jumping.

It is another object of the invention to provide such system where the platform provided to support the user for repelling or jumping is extendable from a vehicle, whether the vehicle is positioned parallel with traffic lanes or at an angle or perpendicular thereto.

Yet, a further object of this invention is the provision of such a portable jumping and repelling platform adapted for use on bridges which is also employable on cliffs through the provision of deployable ramps and safety rails to properly and safely position the jumpers.

Further objectives of the disclosed portable jumping platform herein will be brought out in the following parts of the specification wherein the summary and detailed description of the invention are for the purpose of fully disclosing the invention without placing limitations thereon.

### SUMMARY OF THE INVENTION

The present invention provides a solution to the noted shortcomings in the art of descent platforms for rope repelling and bungee jumping through the provision of a system which provides a vehicle configured with jumping planks or platforms, which are deployable from the parked vehicle at a plurality of angles. In particular the vehicle in the system herein is stationarily positioned upon a bridge in a manner which does not block traffic but still provides an extendable platform which will extend past the bridge structure. So extended, there is no need for securement of platforms, booms, elastic cords or the like to the bridge itself. Such will significantly increase the ability to use bridges which concurrently carry traffic, for rope descents and repelling and in particular for the popular sport of bungee jumping. This is because the vehicle providing the extendable platform can be located out of traffic lanes, thereby removing the objections thereto from governmental agencies.

Further, the system herein is adapted with a deployable platform for jumping or repelling which is slidingly deployable from either the rear or both sides of the vehicle. This multi side translational deployment enables the vehicle to be positioned in an aligned fashion on a bridge or similar traffic carrying structure, and thereby minimize traffic jams from lane blockages. Further, multi-sided translating deployment as well as elevational configurations better enables the system for use on cliffs or the like by the deployment of the jumping platform from the rear of the vehicle which positions the heavy motor and transmission and the like at the opposite end, thereby allowing for longer extensions of the platform used for jumping or repelling in a manner which is safely counterbalanced.

Additionally included are the appropriate safety rails positioned on the translating platform as well as a winch and boom which will translate with all or portions of the platform, thereby providing securement points for ropes or elastic cords upon the vehicle itself. In this fashion, whether on a bridge or cliff, an appropriate platform can be deployed and retrieved by powered translation, from the rear or either of two sides of the vehicle. Repelling users or jumpers are thereby safely positioned on the extended platform which has safety rails in a position which has cleared the bridge or other structure. Jumping or repelling and subsequent retrieval are further handled with no permanent mounts to the bridge or cliff or the like. This is because the securement points for the rope or cord are provided on the tower or vehicle as are the operatively positioned winch and boom, which is deployed upon or engaged with the appropriately deployed platform.

With respect to the above description, before explaining at least one preferred embodiment of the herein disclosed portable extendable platform for repelling or bungee jumping in detail, it is to be understood that the invention is not limited in its application to the details of construction and to the arrangement in the following description or illustrated in the drawings. The vehicle-positioned deployable platform system herein described is capable of other embodiments and of being practiced and carried out in various ways which will become obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for the designing of other portable platforms which may be translated and elevated from their engagement with a vehicle, and for carrying out the several purposes of the present disclosed system. It is important, therefore, that the claims herein be regarded as including such equivalent construction and methodology, insofar as they do not depart from the spirit and scope of the present invention.

### BRIEF DESCRIPTION OF DRAWING FIGURES

The accompanying drawings, which are incorporated herein and form a part of the specification, illustrate some, but not the only or exclusive examples of embodiments and/or features of the invention. It is intended that the embodiments and figures disclosed herein are to be considered illustrative rather than limiting.

In the drawings:

FIG. 1 is a side view of a preferred mode of the deployable portable descent platform system herein showing a rearward translational deployment of the jumping platform which extends over a bridge sidewall by translation from the vehicle and showing the safety rails and boom and cable extending in the same direction from engagement with the translating platform.

FIG. 2 depicts a view of the system of FIG. 1 or FIG. 3, 6-7 or 11, in operative positioning with the descent platform extended, wherein a jumper or repelling user has descended from the platform which is extended past the bridge structure.

FIG. 3 depicts a view of the herein with the descent platform shown having a portion extended from a right side of a vehicle thereby positioning the distal end of that portion of the platform, clear of the bridge structure, wherein a jumper or repelling user has left the distal end of the platform.

FIG. 4 is an overhead illustration of the system herein showing the descent platform in a translating engagement with the vehicle and extending from the rear thereof.

FIG. 5 shows an overhead view similar to FIG. 4, showing the descent platform in the translating engagement with the vehicle and extending from the right side thereof where the platform can also extend from the left side thereof engaged in the same type of translating engagement.

FIG. 6 depicts a view of the system herein wherein the descent platform is in a rotatable engagement with the vehicle and extendable therefrom multiple angles and also shows a telescopic mount allowing for elevational positioning of the platform to adjust it above objects such as a safety rail.

FIG. 7 shows the system herein as in FIG. 6, wherein the descent platform has been rotated to an opposite side of the vehicle and elevated to a level above an object shown as a safety rail.

FIGS. 8-10 depict the system herein as in FIGS. 6,7, and 11, wherein the descent platform is rotated to extend from the vehicle in multiple directions by rotation of the axle engaging the platform to the vehicle.

FIG. 11 shows a mode of the system of FIGS. 7-10, wherein the descent platform is also in a translatable engagement with the vehicle allow it to retract and extend in addition to rotating and changing elevation.

### DETAILED DESCRIPTION OF THE PREFERRED EMBODIMENTS OF THE INVENTION

In this description, any directional prepositions if employed, such as up, upwardly, down, downwardly, front, back, first, second, top, upper, bottom, lower, left, right and other such terms referring to the device or depictions as such may be oriented, are describing it such as it appears in the drawings and are used for convenience only. Such terms of direction and location are not intended to be limiting or to imply that the device herein has to be used or positioned in any particular orientation.

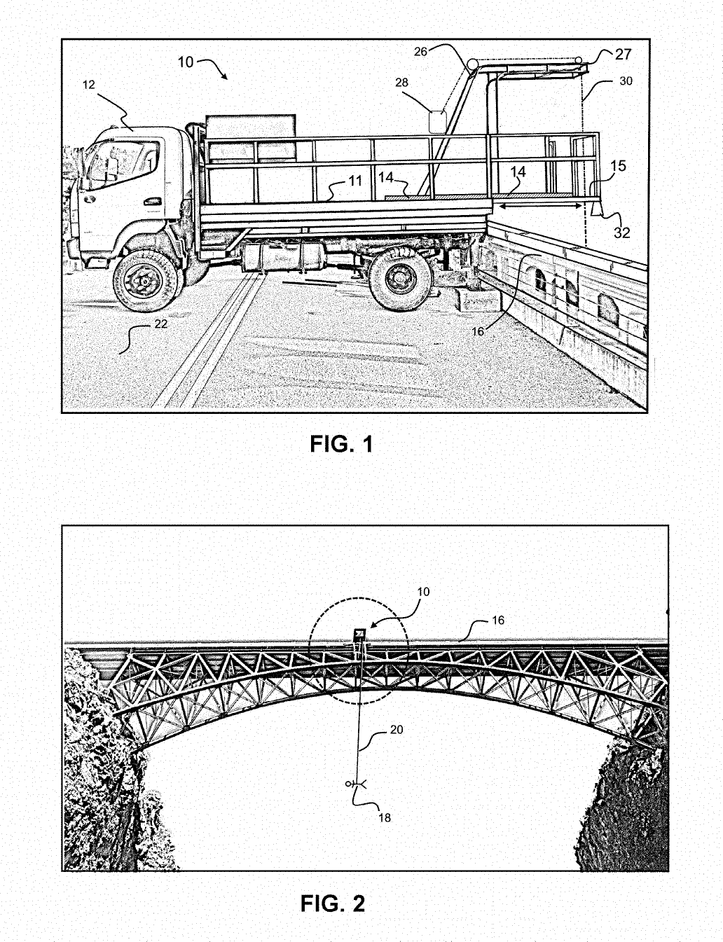

Now referring to drawings in FIGS. 1-11, wherein similar components are identified by like reference numerals, there is seen in FIG. 1 one preferred mode of the descent platform or system 10 herein wherein a motor driven vehicle 12 such as a truck, provides a portable and repositionable mount, for the components required for a user to descent from the platform 14 for a rope descent or bungee jump safely. As noted, in a preferred mode of the system 10, a platform 14 or portion thereof engaged with the distal edge 14 of the platform 14, may translate from a retracted position where it does not extend from the side edges 19 or rear of the vehicle 12, to a deployed position as in FIGS. 1, 6, 7, and 11, wherein the portion of the platform 14 engaged with the distal edge 15 is positioned further or closer from the axle or pivot 36 and thereby further from or closer to a structure such as a bridge 16 or other elevated position such as a cliff edge. The distal edge 15 of the platform 14 so positioned by translating a portion of the platform 14 having the distal edge 15, allows a descending user 18, such as a person repelling from the cord 20 operatively engaged to their person, such as a rope or an elastic cord, to jump or descend safely from the distal end 15 of the platform 14.

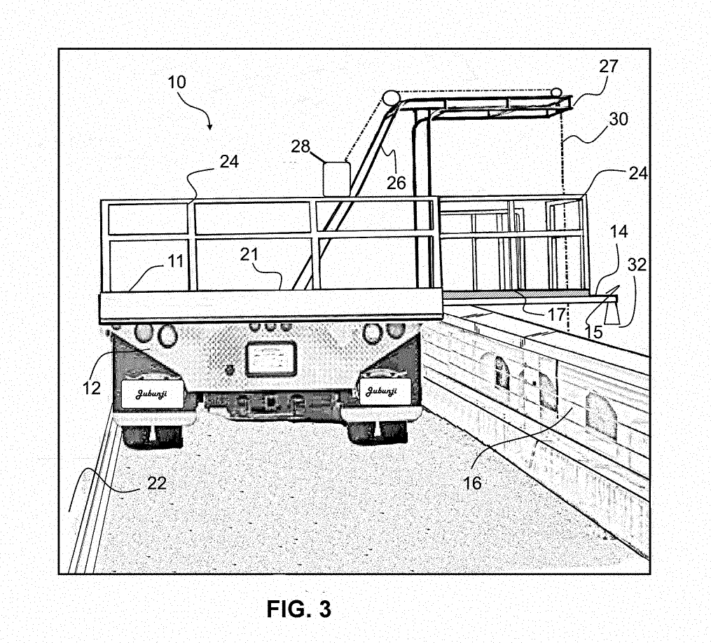

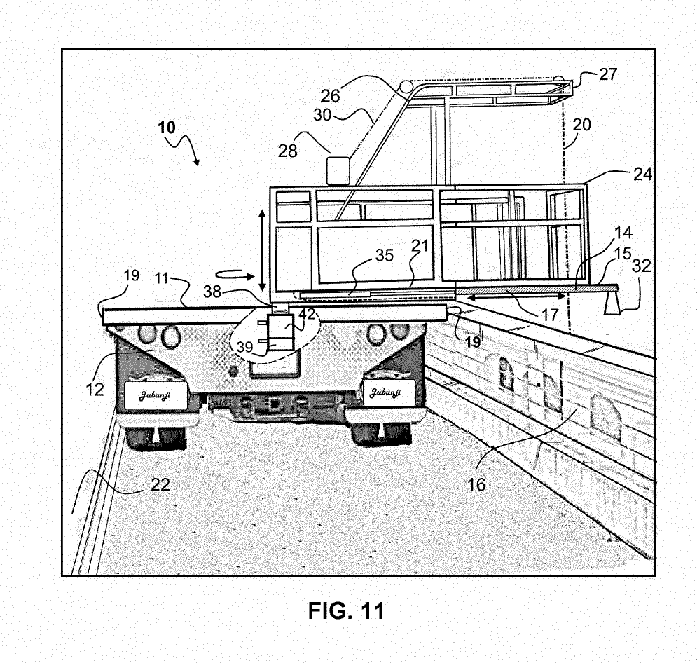

As noted, in the preferred mode of the system 10, the distal edge 15 of the platform 14 is adapted to translate toward and away from the rear of the vehicle 12 as in FIG. 1, or a side edges 19 of the vehicle 12 as in FIG. 3 or 11, and thereby adjust to a proper position, the distal edge 15 of the platform 14 on which a user 18 is positioned. This allows translation of the portion of the platform 14 to position the distal edge 15 thereof on which a user 18 stands, spaced a distance from the bridge 16 or other elevated structure, or from the land or vegetation such as on a cliff top, to allow a safe descent by the user 18 without risk of striking the structure.

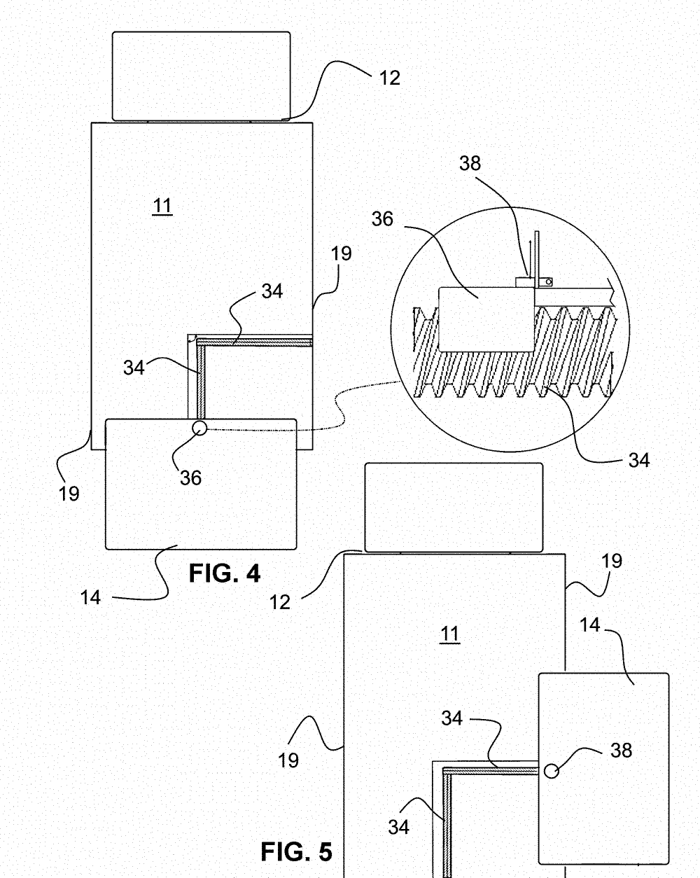

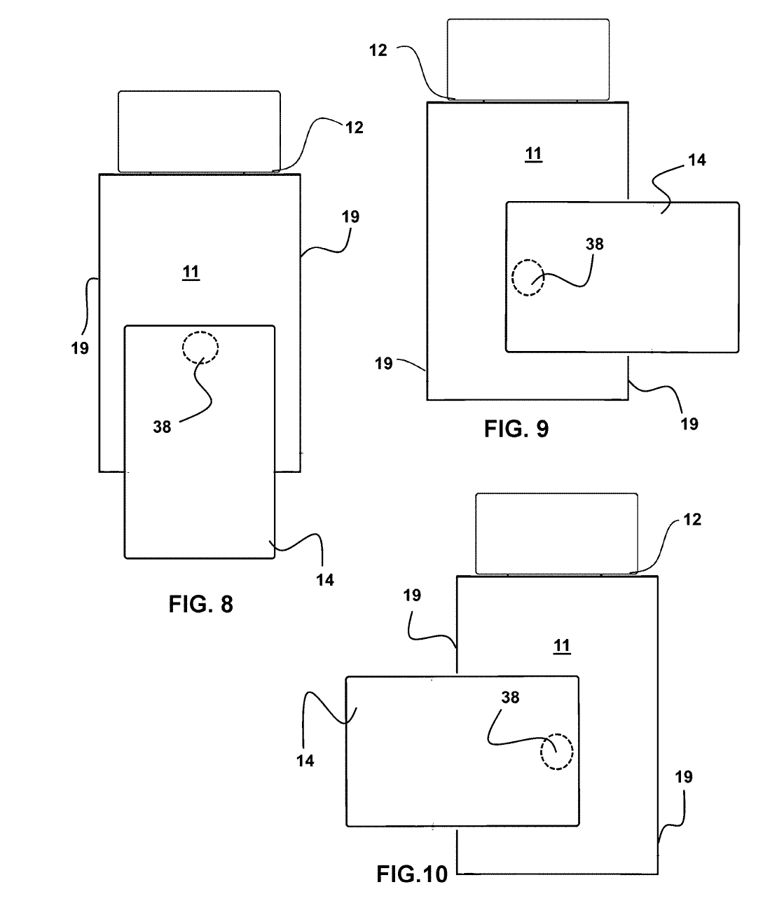

Such a side or rearward translation for positioning of the distal edge 15 of the platform 14 is also desirable as it allows positioning of the vehicle 12 out of the traffic lanes 22 if on a roadway, and parallel thereto during a positioning of the platform 14 to extend the side of the vehicle 12 as in FIG. 3 or 11, to keep traffic lanes 22 clear and thereby prevent traffic jams and the like. Additionally, the rear platform 14 deployment illustrated in FIGS. 4 and 8, is desirable in instances such as on a cliff or bridge where more distance is required for the platform 14 extension, to avoid structural striking hazards to the user 18.

By providing one platform 14 which is deployable in both directions, or two platforms 14, where one deploys rearward and the other sideways, the system 10 provides a significant enhancement to safety and to the number of available venues for a rope descent and/or bungee jumping.

The system 10 herein in all modes, enhances the ability for rope descent and/or bungee jumping in more venues, since it does not require any physical connection to a bridge 16, for the platform 14 or for the secured end of the cord 20, since both are secured only to the vehicle 12. Government agencies conventionally will not allow connections to bridges and other elevated structures for rope descent or bungee jumping due to possible structural damage caused by such connections. Further, as shown in the drawings, the platform 14 and vehicle 14 may also include safety rails 24 which will surround the platform 14 to keep users from falling. Additionally preferably included are a boom 26, a winch 28, and a cable 30 operatively connected to the winch 28.

The cable 30 may run independent of the cord 20, or may actually be the cord 20, or the distal end of the cable 30 opposite the end connected to the winch 28, may be connected to one end of the cord 20 to allow for descent of a user 18 where the cord is a rope, or retrieval of a descended user 18 where they have descended on the cord 20, or where the cord 20 is an elastic flexible member for bungee jumping which is connected at a first end to the cable 30. In modes where the cable 30 runs independent of the cord 20, a distal end of the cable 30 would be removably engageable with a user who has descended from the platform 14, to thereby pull them back up and onto the platform 14 by activation of the winch 28 to wind the cable 30.

The boom 26 may pivot in an engagement at a first end of the boom 26 to the bed 11 of the vehicle 12 or in an engagement of the first end of the boom 26 with a first portion of the platform 14. In this fashion, the boom 26 may thereby be employed with either a rearward deployed platform 14 as in FIG. 1, or side deployed platform 14 as in FIG. 3, 6-7, or 11.

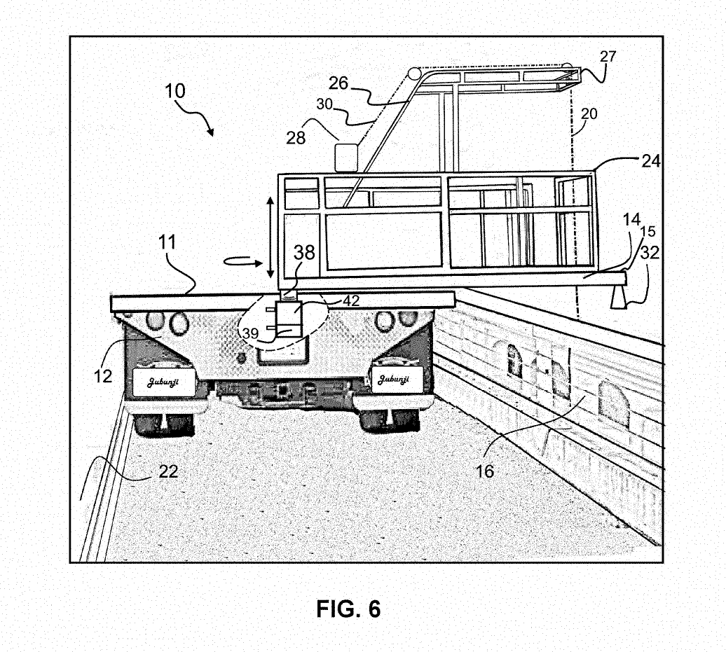

Alternatively, the first end of the boom 26 may be mounted to the translating portion of the platform 14 which would be in a pivoting engagement with the vehicle 10 such as in FIGS. 6-11 where the first portion of the platform 14 is pivotally engaged to the bed 11. A distal end 27 of the boom 26 opposite the engaged first end thereof, is positioned adjacent and overhead or above the distal edge 15 of the platform 14. Thus, the distal end 27 of the boom 26 is adapted for an engagement with a first end of the cord 20 where the opposite end of the cord 20 is operatively connected to a user 18 who descends from the distal edge 15 of the extended platform 14. During translation of the portion of the platform 14 having the distal edge 15, the boom 26 and the distal end 27 thereof, will also move along with the portion of the platform 14 having the distal edge 15.

Other anchor points 32 such as the ring shown, may also be positioned on the vehicle 12 such as at the distal end 15 of the platform 14, to avoid any need to connect to the bridge 16, and to allow use of the system 10 such as on high cliffs where there may not be appropriate anchor points available if such are required.

As noted, the platform 14 can be configured to rotate in its rotational engagement to the vehicle 12 as shown in FIGS. 4-11 and may also translate the portion of the platform 14 having the distal edge 15, toward and away from the pivot 38 with the vehicle 12, using means for powered translation of the second portion 17 of the platform with the first portion of the platform 21. As shown in FIG. 3 and FIG. 11, the second portion of the platform 17 terminating at the distal edge 15 will translate in a sliding engagement with a first portion 21 of the platform 14 which is in a pivoting engagement formed by the axle or pivot 38 running between the bed 11 and the first portion 21 of the platform.

Such means for powered translation of the second portion 17 of the platform 14 may be a driven screw drive 34 in inoperative connection to an engageable threaded component 36, or may be a powered translating drive 35 shown in FIG. 11 such as a solenoid or pneumatic cylinder or hydraulic cylinder, which is in inoperative connection to an engageable threaded component 36. Actuation of the means for powered translation will cause force to be communicated thereto such as electric power or compressed fluid, and thereby cause translation thereof which can be reversed by reversing the electric power or flow of fluid. Such actuation controls are well known for electric and hydraulic and pneumatic power to those skilled in the art.

Actuation of such means for powered translation will thus cause the distal edge 15 of the platform 14 to translate toward or away from the axle or pivot 36 forming the pivoting engagement at or near the first end of the platform 14 to the bed 11, thereby moving the distal edge 15 on which a user 18 would be positioned, closer to or further from the side edges 19 of the bed 11 and/or closer to or further from the pivoting engagement formed by the axle or pivot 38.

Using the driven screw drive 34 engaged with the threaded component 36, the platform 14 would be in a pivoting engagement with the bed 11 on an axle or a pivot 38, and the threaded component 36 may be lifted off one screw drive 34, and engaged to another depending on the direction of translation of the platform 14 desired. Alternatively but heavier and more expensive, two platforms 14 could be connected to translate in the two directions.

Also as shown in FIGS. 4-5 where the means for powered translation is shown as the driven screw drive 34 in inoperative connection to an engageable threaded component 36, the platform 14 is shown translating from the rear and right side of the vehicle 12 by pivoting the platform 14 in its engagement to the driven screw drive 34, which is shown but would be recessed into the bed 11.

While not shown in detail, the driven screw drive 34 also will extend toward the left side of the vehicle 12 recessed into the bed 11. In this fashion when the platform 14 is retracted and supported upon the surface of the bed 11, the user may disengage and re-engage the threaded component 36 by lifting it off any of the three driven screw drives 34, and sliding over the top edge of any of the other driven screw drives 34 as shown in the detailed portion of FIG. 4. Prior to engagement or afterwards, the platform 14 may then be rotated to the direction the user wishes it to extend from the vehicle 12.

In FIG. 6 is shown a view of the system 10 herein wherein the platform 14 is in a rotatable engagement with the vehicle 12 on a powered pivot 38 which is rotatable with a motor 39 which may be electric or hydraulic or pneumatic. Activation of the motor 39 will thus rotate the pivot 38 which in this mode would be an axle. In the modes of the system 10 shown in FIGS. 6-11, this pivot 38 which is motor 39 driven, allows the vehicle 12 to be positioned properly adjacent the edge of the highway, and the platform 14 to then be rotated by activation of the motor 39 to the desired angle for projection from the vehicle 12 such as rearward as in FIG. 8, or from the right side as in FIG. 9 or from the left side as in FIG. 10, or any position in-between the right side projection and the left side projection thereby allowing for powered angled positioning of the platform 14.

Additionally shown in FIG. 6, and applicable to any mode of the system 10 herein such as in FIG. 7-11 or 1-3, is shown a vertical translation drive 42 operatively engaged with the axle or pivot 38. This vertical translation drive 42 is powered to raise and lower the end of the pivot 38 engaged with the platform 14. It is powered to translate the axle or pivot 38 along a line substantially perpendicular to the bed 11 of the vehicle 12, and thereby adjust the height of the platform 14 above the bed 11. The vertical translation drive 42 may be any motor or driven cylinder or solenoid or the like, adapted to impart sufficient force to raise and lower the platform 14 away from and toward the bed 11, such as an electric motor or electric driven cylinder or pneumatic driven cylinder or hydraulic driven cylinder, all of which are well known and need not be depicted in detail. As shown in FIG. 6, adjusting the height of the platform 14 allows for positioning it above obstacles during translation of the distal end 15 away from the structure.

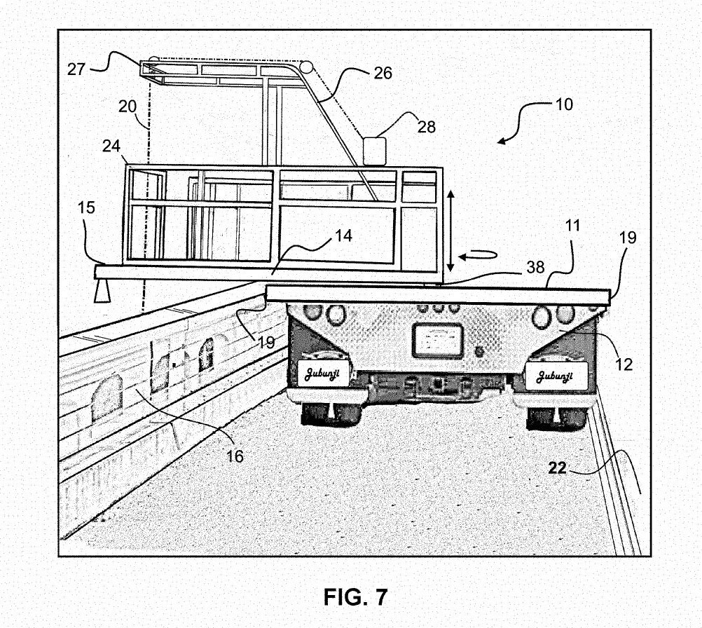

As noted, FIG. 7 shows the system 10 herein as in FIG. 6, and depicts the platform 14 having been rotated by the motor 39 engaged with the axle or pivot 38 which is connected to the platform 14, to an opposite side of the vehicle 12 from that of FIG. 6. Further, the vertical translation drive 42 has been powered to raise the platform 14 to a desired level whereby the powered translating drive 35 can translate the distal end 15 of the platform 14 a distance from the bridge structure and for example the guard rail.

As already noted above, FIGS. 8-10 are graphic depictions of the positions to which the platform 14 can be remotely rotated by activation of the motor 39 operatively connected to the axle or pivot 38. As also noted, the platform 14 can be located to any angle relative to bed 11 and axis of the vehicle 12 in-between the positions shown for the platform 14 in FIGS. 9 and 10.

Finally, as discussed above, FIG. 11 shows the system 10 depicted in FIGS. 6-10, wherein the platform 14 is also in a translatable engagement with the vehicle 12 and the powered extension drive 35 is operatively engaged to translate the platform 14 and distal end 15. As shown, the powered extension drive 35 such as a solenoid, or hydraulic powered cylinder, or pneumatic powered cylinder, will translate the platform 14 between a retracted position where the distal end 15 would be proximate to a side edge 19 of the bed 11, to the shown extended position where the distal end 15 of the platform 14 is spaced from the bridge 16 or railing, or other structures and provides an unimpeded path for the user 18 to descend from the distal end 15 of the platform 14. Since it would be powered adjustments to the position of the distal end 15 of the platform 14 are easily obtained during initial positioning of the system 10 for use.

Further, the mode shown in FIG. 11 also includes the axle of pivot 38 being operatively engaged with the vertical translation drive 42 as well as the motor 39 to thereby allow adjustment of the angular extension of the platform 14 from the bed 11 and vehicle 12 as well as the elevation of the platform 14 above the bed 11 and surrounding roadway and any impeding objects to translation of the distal end 15 from the bed 11. This mode of the system 10 with vertical translation adjustment, horizontal translation adjustment, and rotational adjustment of the position of the platform 14 would be the most functional and preferred.

While all of the fundamental characteristics and features of the portable descent system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful device and system herein disclosed, that various substitutions, modifications, and variations may occur to and be made by those skilled in the art, without departing from the spirit or scope of the invention. Consequently, all such modifications and variations and substitutions, as would occur to those skilled in the art are considered included within the scope of the invention as defined by the following claims.

What is claimed is:

1. A portable descent platform apparatus, comprising:
a vehicle having a substantially planar bed;
a platform having a first end opposite a distal edge;
said platform in a pivoting engagement to said bed at or adjacent said first end of said platform;
said platform rotatable around said pivoting engagement to an angular positioning between a first position with said platform extending from a first side edge of said bed to a second position with said platform extending from a second side edge of said bed opposite said first end;
a boom having a first end engaged with one of the platform or bed, said boom extending to a distal end located adjacently overhead of said distal edge of said platform; and
said distal end of said boom adapted for a connection to a first end of a cord which is connected to a user descending from said distal edge of said platform.

2. The portable descent platform apparatus of claim 1, additionally comprising:
a motor engaged with said pivoting engagement, said motor actuable to rotate said platform between said first position and said second position.

3. The portable descent platform apparatus of claim 1, additionally comprising:
a vertical translation drive engaged with said pivoting engagement;
said vertical translation drive actuable to translate said platform in said pivoting engagement toward and away from said bed of said vehicle, thereby positioning said distal edge of said platform toward and away from said bed.

4. The portable descent platform apparatus of claim 1, additionally comprising:
a first portion of said platform being slidably engaged with a second portion of said platform extending to said distal edge of said platform;
said first portion of said platform in said pivoting engagement to said bed at or adjacent said first end of said platform; and
means for powered translation of said second portion of said platform, said means of powered translation actuable to translate said distal edge of said platform, toward and away from said pivoting engagement of said platform to said bed, to thereby position said distal edge of said platform to positions closer to or further from said pivoting engagement.

5. The portable descent platform apparatus of claim 2, additionally comprising:
a first portion of said platform being slidably engaged with a second portion of said platform extending to said distal edge of said platform;
said first portion of said platform in said pivoting engagement to said bed at or adjacent said first end of said platform; and
means for powered translation of said second portion of said platform, said means of powered translation actuable to translate said distal edge of said platform, toward and away from said pivoting engagement of said platform to said bed, to thereby position said distal edge of said platform to positions closer to or further from said pivoting engagement.

6. The portable descent platform apparatus of claim 3, additionally comprising:
a first portion of said platform being slidably engaged with a second portion of said platform extending to said distal edge of said platform; and
said first portion of said platform in said pivoting engagement to said bed at or adjacent said first end of said platform;
means for powered translation of said second portion of said platform, said means of powered translation actuable to translate said distal edge of said platform, toward and away from said pivoting engagement of said platform to said bed, to thereby position said distal edge of said platform to positions closer to or further from said pivoting engagement.

7. The portable descent platform apparatus of claim 2, additionally comprising:
a vertical translation drive engaged with said pivoting engagement;
said vertical translation drive actuable to translate said platform in said pivoting engagement toward and away from said bed of said vehicle, thereby positioning said distal edge of said platform toward and away from said bed.

8. The portable descent platform apparatus of claim 4, additionally comprising:
a vertical translation drive engaged with said pivoting engagement;
said vertical translation drive actuable to translate said platform in said pivoting engagement toward and away from said bed of said vehicle, thereby positioning said distal edge of said platform toward and away from said bed.

9. The portable descent platform apparatus of claim 5, additionally comprising:
a vertical translation drive engaged with said pivoting engagement;
said vertical translation drive actuable to translate said platform in said pivoting engagement toward and away from said bed of said vehicle, thereby positioning said distal edge of said platform toward and away from said bed.

10. The portable descent platform apparatus of claim 3, additionally comprising:
a motor engaged with said pivoting engagement, said motor actuable to rotate said platform between said first position and said second position.

11. The portable descent platform apparatus of claim 4, additionally comprising:
a motor engaged with said pivoting engagement, said motor actuable to rotate said platform between said first position and said second position.

12. The portable descent platform apparatus of claim 6, additionally comprising:
a motor engaged with said pivoting engagement, said motor actuable to rotate said platform between said first position and said second position.
